(19) United States
(12) Patent Application Publication
(10) Pub. No.: US 2019/0005526 A1
(43) Pub. Date: Jan. 3, 2019

(54) Electronic Coupon Fund Raising Program

(71) Applicants: Alexander S. Ewell, Modesto, CA (US); Timothy V. Ewell, Modesto, CA (US)

(72) Inventors: Alexander S. Ewell, Modesto, CA (US); Timothy V. Ewell, Modesto, CA (US)

(21) Appl. No.: 15/944,580

(22) Filed: Apr. 3, 2018

Related U.S. Application Data
(60) Provisional application No. 62/480,767, filed on Apr. 3, 2017.

(51) Int. Cl. G06Q 30/02

(52) U.S. Cl. CPC G06Q 30/0213; G06Q 30/0279

(57) ABSTRACT

A plurality of databases contain data regarding merchants, charities and consumers. A network and server system enable consumers to donate funds to charities. Upon making a donation, a consumer is awarded system points or system credits that may be used to purchase goods and services from enrolled merchants. Upon entry into an enrolled merchant store, a consumer may select an item and then be presented with a discount amount in reaction to the consumer's previous donations made through the system. A system discount may be authenticated by use of a system generated discount code. Disclosed embodiments include means and methods of allowing consumers to leave comments and ratings to enrolled merchants.

### CROSS-REFERENCE TO RELATED APPLICATIONS

This utility patent application claims the benefit and priority of U.S. patent application 62/480,767 filed on Apr. 3, 2018.

### BACKGROUND OF THE INVENTION

### (1) Field of the Invention

The invention generally relates to fund raising and discount card systems. More particularly, the invention relates to means and methods of creating an electronic server, database and other systems to facilitate a fund raising account system interfacing with an integrated discount system.

### (2) Description of the Related Art

The known related art fails to anticipate or disclose the principles of the present invention.

In the related art, generalized discount cards are known.

In a somewhat related field, online donation systems are known.

The known related art fails to artfully combine consumer donation systems with merchant discount or coupon systems.

Thus, there is need in the art for the present invention.

### BRIEF SUMMARY OF THE INVENTION

The present invention overcomes shortfalls in the related art by presenting an unobvious and unique combination and configuration of methods and components to facilitate consumer donations via electronic means that triggers a discount coupon to the relevant consumer. The consumer may then use the discount coupon with a system authorized merchant. The receiving merchant may then reuse the discount coupon within the authorized network of system participants.

Disclosed embodiments overcome shortfalls in the art wherein consumers make donations but receive little or no tangible assets in return. Disclosed embodiments overcome shortfalls in the art wherein merchants provided coupons, goods or services at a discount, and have no way to reuse the coupons they receive.

Disclosed embodiments may be described as follows:

A consumer database system issues applications or computer programs to consumer devices or provides a web based interface to allow consumers to create a consumer account.

A registered consumer may donate money to a registered or a participating non-profit organization. A separate non-profit database may be part of the overall system.

Upon executing a donation within the disclosed system, the registered consumer obtains points or other indicia of participation. Issued points may be exchanged for discounts with system registered merchants. A separate merchant database may be part of the overall system. System components may list or publish information regarding the registered merchants.

A registered consumer may tender or transfer points for a discounted purchase (never an outright purchase) for goods or services from a registered merchant. Each transaction will generate a various transaction numbers and information. System components may include a separate transaction database. Transaction information may be available to registered merchants such that registered merchants may perform data analytics and otherwise track transactions and arising merchant credit.

Registered merchants may collect points for discounts given and then reuse such points within the system. The reuse of points by merchants may follow the same protocol as points used by a consumer. Thus, a registered merchant obtains valuable consumer data and obtains points for reuse, with the necessity of making a donation.

Overall, disclosed embodiments help non-profits raise needed funds, help consumers save money in the purchase of goods and services and help merchants: 1. increase sales via controlled discounts; 2. Increase knowledge of consumer habits by review of past transaction information; 3. Save money by obtaining system discount points.

Disclosed embodiments overcome the prior art by presenting various user interfaces to allow various forms of communication between the various parties of the system. For example, a charity may register with the system and receive various donations on a one time basis or on a monthly basis. The registered charity may send messages to the various subscribing consumers. Thus, the charity may increase public awareness of its cause. Subscribing consumers may send private or public messages or reviews to either subscribing charities and/or subscribing merchants.

The disclosed embodiments overcome shortfalls in the related art by allowing merchants to reuse points collected from consumers. Thus, a consumer may make a charitable donation, obtain points, use the points with a merchant. The merchant may then reuse the points with another merchant.

These and other objects and advantages will be made apparent when considering the following detailed specification when taken in conjunction with the drawings.

### BRIEF DESCRIPTION OF THE DRAWINGS

FIG. 1 depicts a schematic view of a disclosed system

FIG. 2 provides a flow chart of a disclosed process

FIG. 3 depicts a flow chart of disclosed systems and methods as executed with a personal electronic device

FIG. 4 depicts a starting interface for a consumer

FIG. 5 depicts an initial shopping interface

FIG. 6 depicts an initial list of organizations

FIG. 7 depicts an initial donation interface

FIG. 8 depicts a percentage of sharing interface

FIG. 9 depicts a search for businesses interface

FIG. 10 depicts a selection of a business

FIG. 11 depicts an interface displaying business attributes

FIG. 12 depicts a price calculation interface

FIG. 13 depicts a transaction total interface

FIG. 14 depicts a post-sale communication interface

### REFERENCE NUMERALS IN THE DRAWINGS

100 a central server system

200 a plurality of databases

210 a database of non-profit organizations

220 a database of registered consumers

230 a database of registered merchants

240 a database of past transactions including consumer analytics

300 a representative consumer

400 a representative merchant

500 a disclosed process in general

510 account set up

520 credits or points transferred to consumer

530 points or discounts may be redeemed with a merchant

540 a merchant may view points redeemed at the merchant's store

550 a merchant may reuse points collected from consumers

600 general interface system

610 consumer home screen interface

620 initial shopping and point interface

630 initial charity selection interface

640 initial donation interface

650 percentage of donation interface

660 initial search for merchants interface

670 merchant drop down selection interface

675 merchant attribute interface

680 price and/or discount interface

685 competed transaction interface

690 post sale communication interface

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

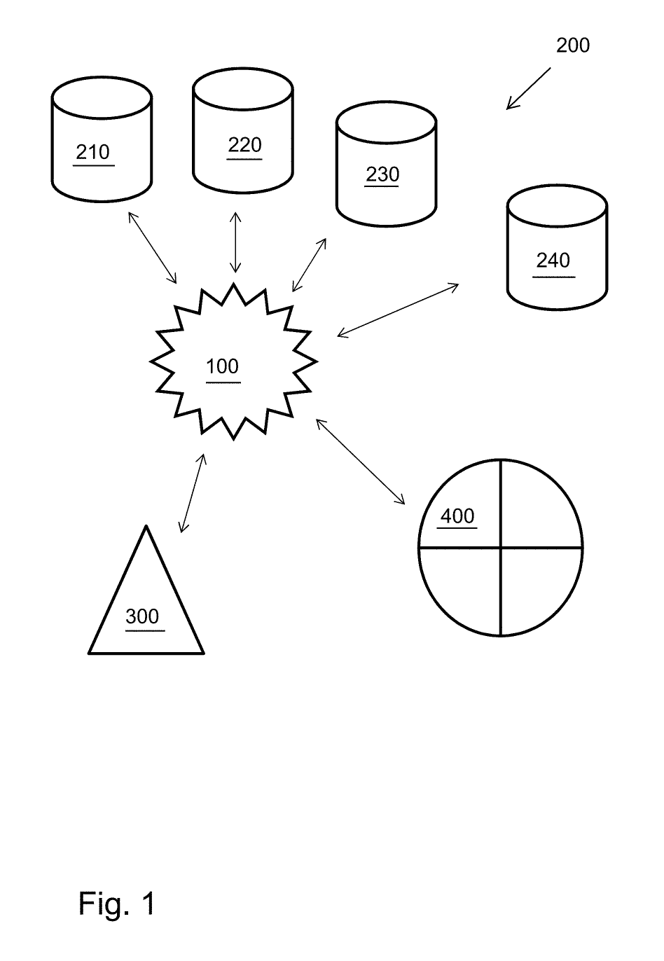

FIG. 1 depicts a contemplated computerized system using network systems, the Internet, mobile applications, web based interfaces and other machinery to facilitate a central server system 100 that is in communication with network systems and well as a plurality of databases 200, merchants 400 and consumers 300.

The plurality of databases 200 may include a database of non-profits 210, registered consumers 220, registered merchants 230 and past transactions 240 including consumer analytics.

Consumers may be in communication with the server system 100 to download a mobile application or to log on to a web based user interface. As consumers make donations they receive system points that may be exchanged for discounts with registered merchants 400. As transactions occur, transaction data is recorded in a database of past transactions 240.

Merchants 400 are uniquely positioned to review information upon the database of past transactions 240 in order to better understand consumer behavior and other consumer variables.

Moreover, merchants 400 enjoy the privilege of reusing collected coupons, thus giving extra incentives to attract merchants to become participating or registered merchants.

The disclosed embodiments include special purpose databases, special purpose processors and other improvements to the utilized computer hardware.

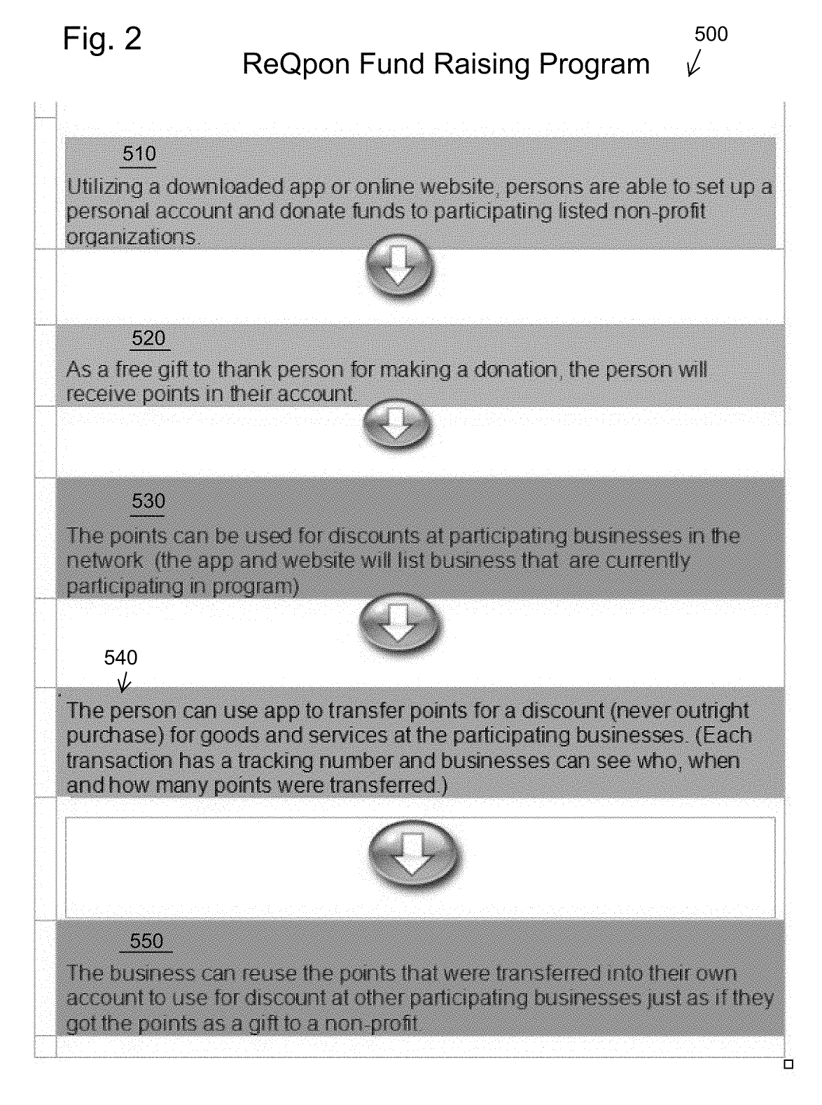

FIG. 2 depicts flow chart of a claimed embodiment. In one contemplated system or method, a user or consumer may download an application or computer program. The computer program may run upon the consumer's phone or other electronic device. Upon registration into a disclosed embodiment, a user may establish a personal account and donate funds to a participating non-profit or charitable organization.

A disclosed process 500 or system may include a first step 510 may include a consumer, charity or merchant creating a system account.

A second step 520 may include a consumer making a donation to a registered charity. After a donation is made, a system server or system database may transfer system points to the consumer's account.

A third step 530 may include a consumer redeeming or using points with a participating merchant. The consumer's points may be used for predetermined discount amounts or discount percentages.

A forth step 540 may include a reporting to a merchant of points redeemed at the merchant's store.

A fifth step 550 may include a merchant reusing points with another merchant.

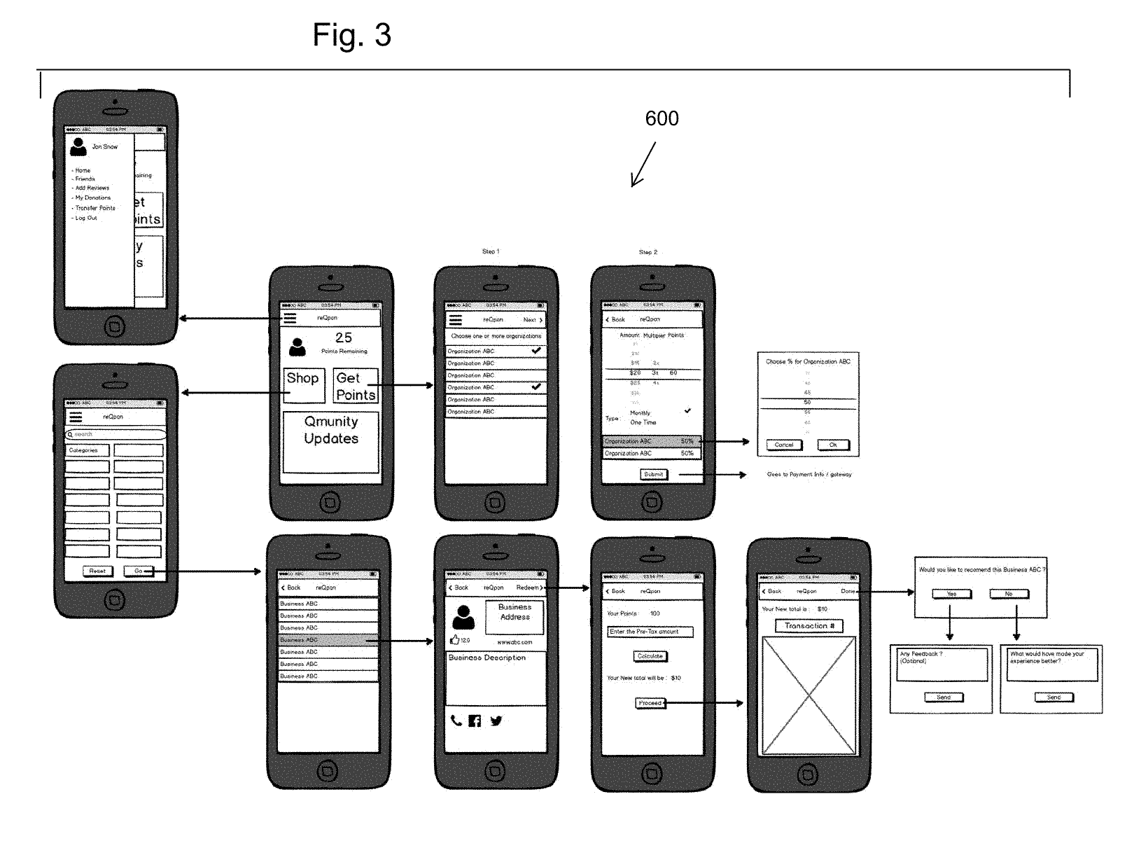

FIG. 3 depicts disclosed user interfaces and systems that implement the objectives of the invention within or upon a personal electronic device. The user interfaces are more completely shown in the drawings that follow.

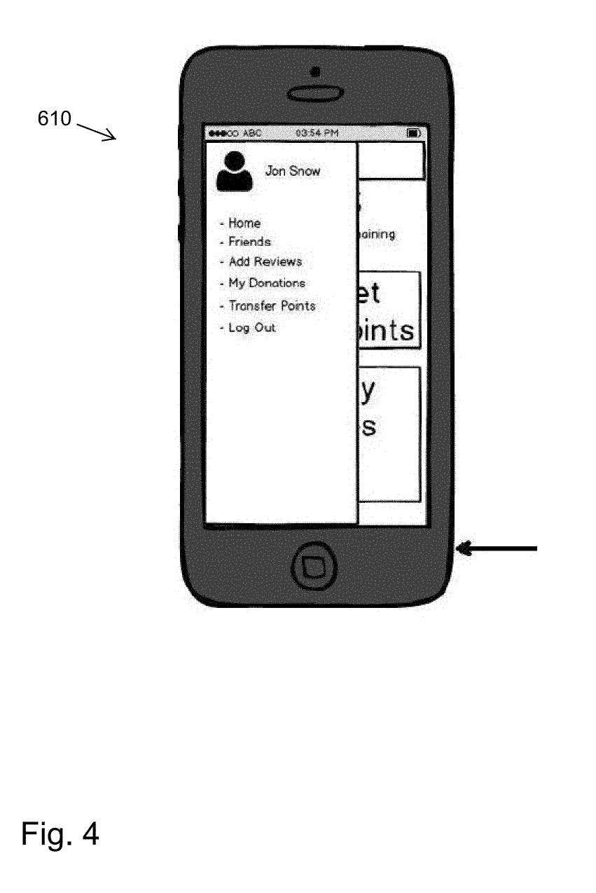

FIG. 4 depicts a starting interface 610 for a consumer. The interface may include hyperlinks or menus that include home, friends, add reviews, my donations, transfer points and log out. This starting interface may be imposed over a initial shopping interface shown in the next figure.

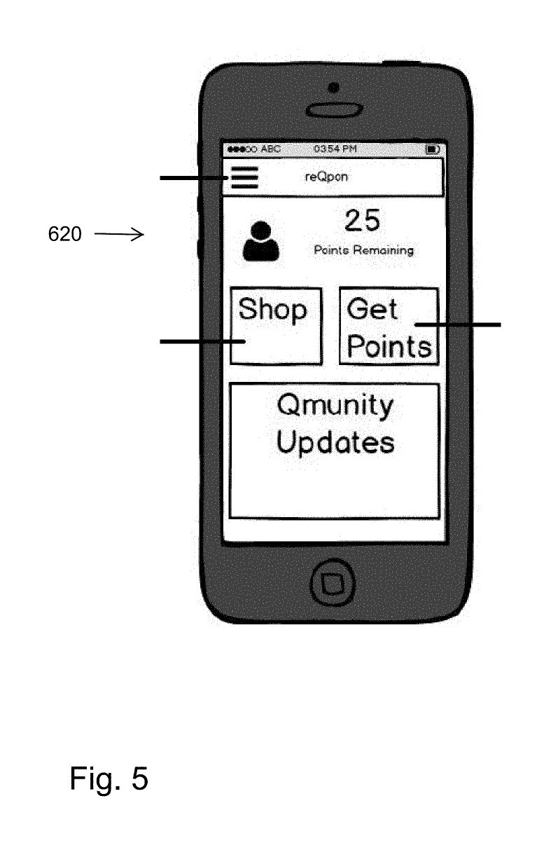

FIG. 5 depicts an initial shopping interface 620 that may include an icon or hyperlink area for shop, get points and community updates.

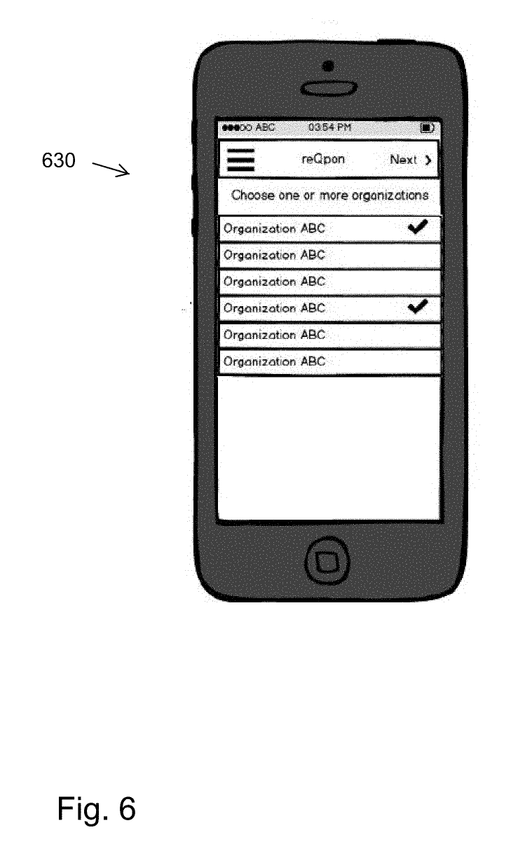

FIG. 6 depicts an initial charitable organization interface 630 that may display a plurality of charitable organizations that have joined the system. A user may select one or more charitable organizations by use of added indicia such as check marks next to the organizations.

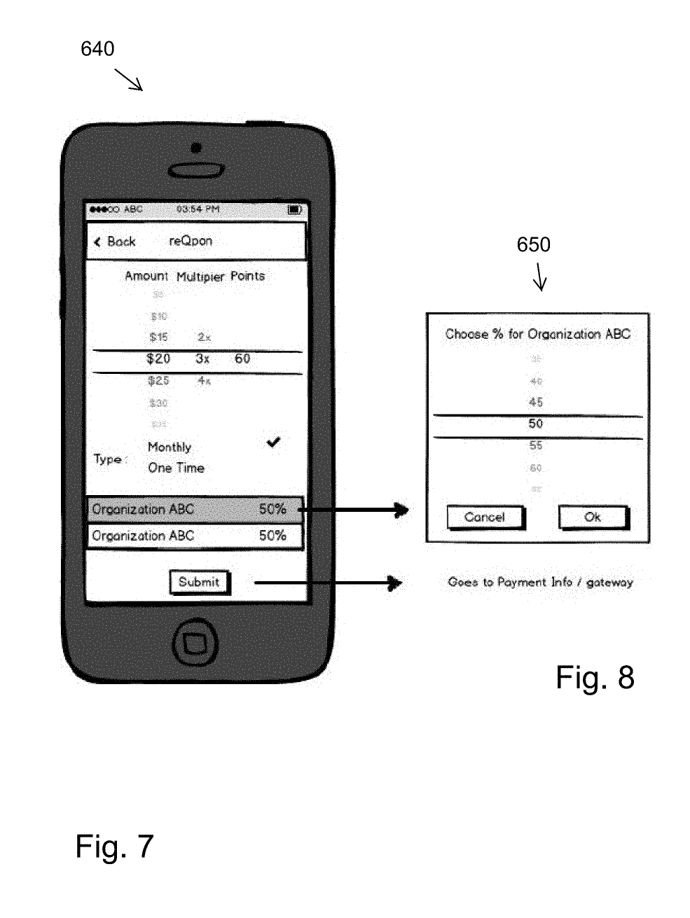

FIG. 7 depicts an initial donation interface 640 that may include a wheel or drop down selection menu for amounts to donate and multiplier properties or values for each donation. The use of interface multipliers overcomes shortfalls in the art by encouraging increasing donations to earn a greater point multiplier. System parameters for multiplier values may be adjusted to comport with market trends. The use of the multiplier interface may provide a number to multiple to derive the points awarded in response to a donation. The subject interface may also include a radio button or other indicia to offer or allow periodic donations.

FIG. 8 depicts a percentage of sharing interface 650 allowing a consumer to select the percentage of donation to be allocated to a selected charity. This interface and system overcomes shortfalls in the related art by encouraging consumers to derive one amount to donate on a one time or monthly basis. The total donation may then be shared with a plurality of charitable organizations as allocated by the consumer.

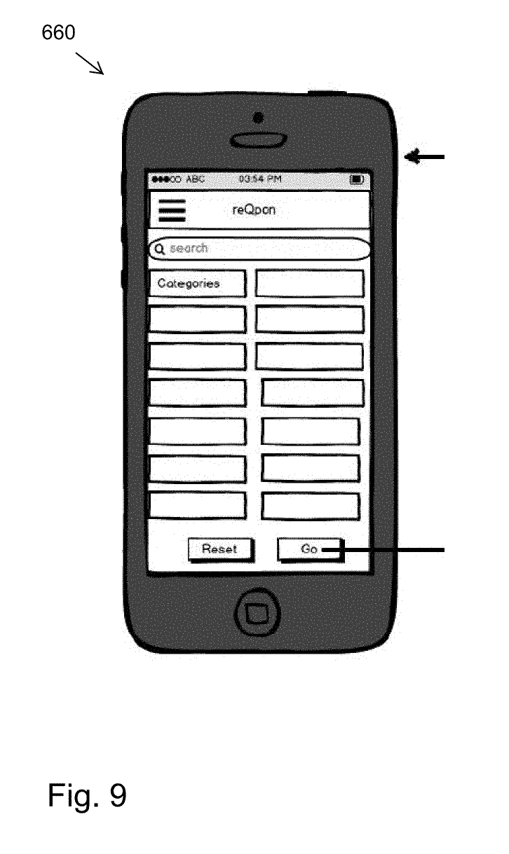

FIG. 9 depicts a search for merchants interface 660. The interface may include radio buttons and/or hyperlinks to categories of businesses as well has a search interface.

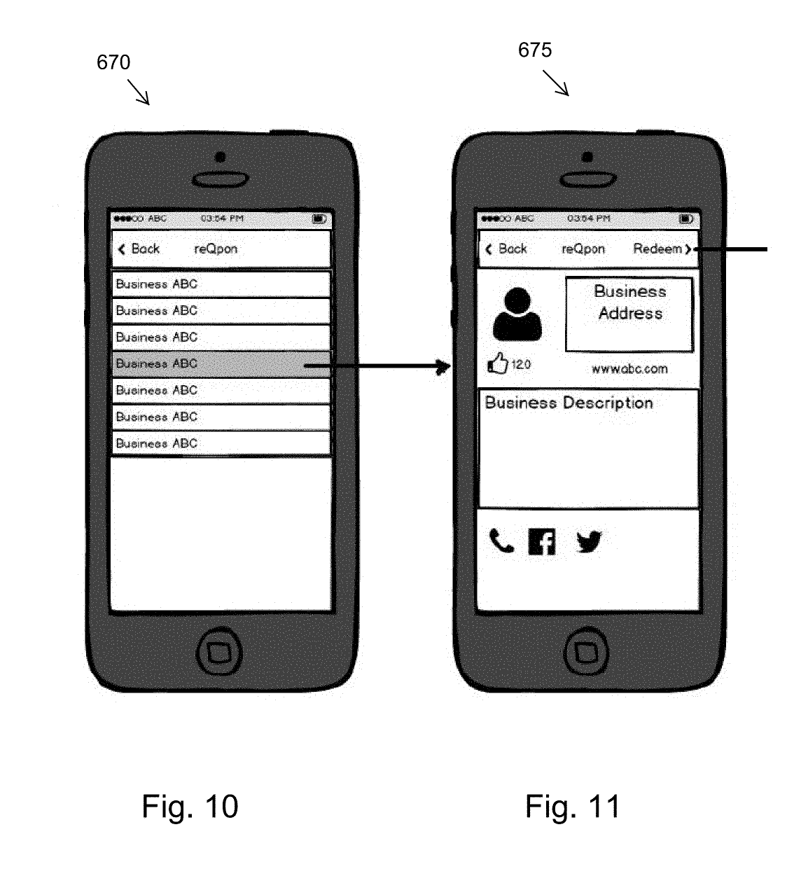

FIG. 10 depicts business or merchant listing interface 670 that may present a plurality of merchants comporting to the user input of the prior interface.

FIG. 11 depicts an interface of business attributes 675 which may include an upper display area or map for other system functions or displays such as back, coupon and redeem. The displayed business attributes may include name, address, link to website and a brief description.

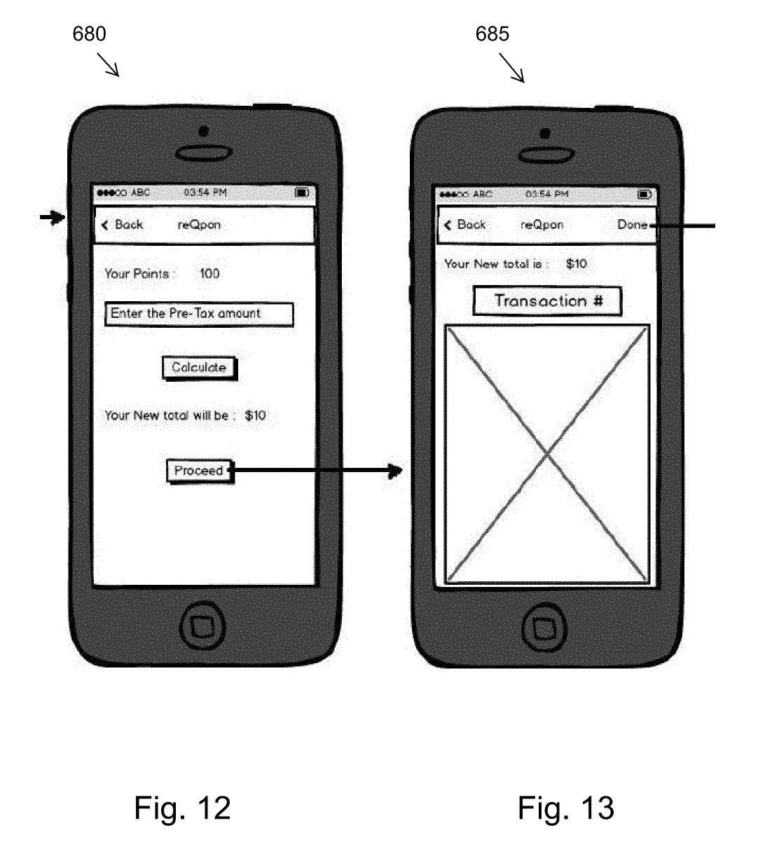

FIG. 12 depicts a price and/or discount interface 680 that may include an initial or undiscounted purchase price, consumer points available for use and a reduced cost window to reflect the discount given.

FIG. 13 depicts a transaction total interface 685 that may display the total cost to the consumer.

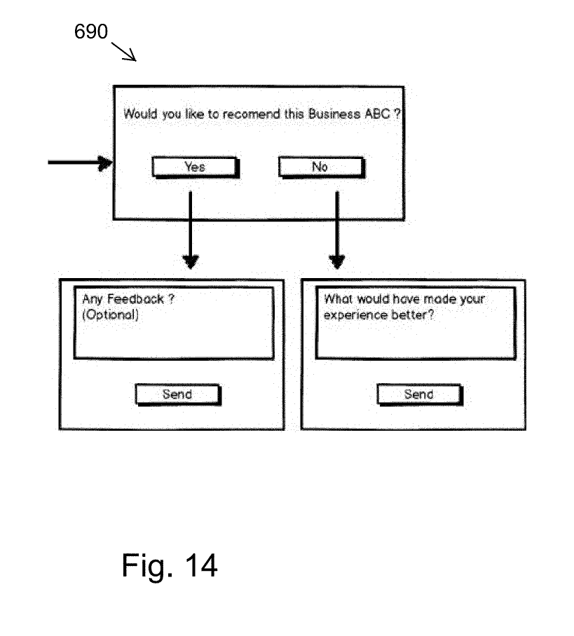

FIG. 14 depicts a post sale communication interface 690 that includes interfaces for sending a public message regarding the subject merchant, a private message to the subject merchant or a rating for the subject merchant.

What is claimed is:

1. An interface system (600) used to convert charitable donations into discounts with enrolled merchants, the interface system comprising:
a) a consumer home screen interface (610);
b) an initial shopping and point interface (620) comprising a shop icon, a get points icon, a community update icon and a points remaining display;
c) a charity selection interface (630) comprising a plurality of enrolled charities and comprising means to select charities for donations; and
d) an initial donation interface (640) comprising an amount to donate column, a donation multiplier column, a points column and a percentage of donation row, wherein the values of the percentage of donation row are selected upon a percentage of donation interface (650).

2. The interface system of claim 1 further comprising:
a) an initial search for merchants interface (660);
b) a merchant drop down selection interface (670);
c) a merchant attribute interface (675);

3. The interface system of claim 2 further comprising:
a) a price and discount interface (680);
b) a completed transaction interface (685);
c) a post sale communication interface (690).

4. The interface system of claim 1 further comprising and in communication with a system server (100).

5. The interface and server system of claim 4 in communication with a plurality of databases (200), the plurality of databases comprising a non-profit organizations database (210), registered consumers database (230) and a registered merchants database (230).
